(19) United States
(12) Patent Application Publication
(10) Pub. No.: US 2021/0389010 A1
(43) Pub. Date: Dec. 16, 2021

(54) HEAT LOSS COEFFICIENT VALIDATION

(71) Applicant: Redbarn Group Limited, Hereford (GB)

(72) Inventors: Thomas Ashley FENTON, Hereford, Herefordshire (GB); Mark William FENTON, Hereford, Herefordshire (GB); Clare Jane FENTON, Hereford, Herefordshire (GB); Paul Daniel BAXTER, Cambridge, Cambridgeshire (GB)

(73) Assignee: Redbarn Group Limited, Hereford (GB)

(21) Appl. No.: 17/282,786

(22) PCT Filed: Oct. 4, 2019
(86) PCT No.: PCT/GB2019/052803

§ 371 Date: Apr. 5, 2021

(30) Foreign Application Priority Data
Oct. 5, 2018 (GB) 1816290.9

(51) Int. Cl. F24F 11/63; G01K 13/00

(52) U.S. Cl. CPC F24F 11/63; G01K 13/00

(57) ABSTRACT

A method of validating whether a building or building portion has a design target heat loss coefficient is disclosed. According to the method, also known as the VeriTherm method, a plausible range of heat loss coefficients is determined in which an estimated measurement error does not exceed a combined sensor bias. An indication of whether the design target heat loss coefficient is validated is provided depending on whether or not the design target heat loss coefficient is inside the plausible range of heat loss coefficients. An apparatus may include modules adapted to perform the steps of the method. Further, a method of heating or cooling a building portion is disclosed. According to the method a power input to a building portion is determined in dependence on one or more of: a design target heat loss coefficient, a desired maximal internal to external temperature difference, a cut-off temperature, an intended period of measurement, and a heating/cooling period.

The present invention relates to validating whether a building or building portion has a design target heat loss coefficient.

In order to gain confidence that a building has been built according to specification, it is desirable to investigate the heat loss coefficient of the building. Measuring the heat loss coefficient of a building can be challenging due to a number of complicating factors such as solar heating and wind effects. Consequently an approach is desired to overcome these challenges.

According to one aspect there is provided a method of validating whether a building portion has a design target heat loss coefficient, comprising the steps of: determining a plausible range of heat loss coefficients in which an estimated measurement error does not exceed a combined sensor bias; and providing an indication of whether the design target heat loss coefficient is validated depending on whether or not the design target heat loss coefficient is inside the plausible range of heat loss coefficients.

By determining a range of plausible candidate heat loss coefficients, instead of attempting to establish a single most likely measured heat loss coefficient, relatively scarce measurement date can be used. Using scarce measurement data means that measurement for relatively short periods can be sufficient, such as over a single night. This in turn can lead to avoidance of complicating factors, such as solar heating and weather effects, in the evaluation of measurements. It is recognised that in many situations it is sufficient to determine whether the design target heat loss coefficient is a plausible heat loss coefficient given the measurement data, without providing any further detail as to what the actual heat loss coefficient is. The present method validates a design heat loss coefficient by determining if it is consistent with measurements, or not, without attempting to determine an actual heat loss coefficient. The means for determining a range of plausible heat loss coefficients lies in the comparison of estimated measurement errors and combined sensor bias. A range of candidate heat loss coefficients is evaluated, and for each candidate heat loss coefficient a measurement error is determined consistent with measurement data describing that candidate heat loss coefficient. The measurement error can then be compared to a combined sensor bias determined from performance data of sensors for taking measurement data.

Preferably the method further comprises one or more of the following steps: receiving a design target heat loss coefficient; determining a range of candidate heat loss coefficients, preferably in dependence on a design target heat loss coefficient; receiving measurement data in the form or temperature time series data representing temperature of the interior and exterior of the building portion and/or power time series data representing heating/cooling power input to the building portion; receiving sensor bias data for measurement data; determining for each candidate heat loss coefficient an estimated measurement error in dependence on the measurement data; and determining for each candidate heat loss coefficient a combined sensor bias in dependence on the sensor bias data.

To avoid or minimise the impact of complicating factors the measurement data may relate to data obtained in a period of measurement of 16 hours, 14 hours, 12 hours, 10 hours, 8 hours, one night, two nights, or less. The measurement data preferably relates to data obtained in a single and/or continuous period of measurement. For example for a particularly well insulated building portion, the measurement data may relate to data obtained in two periods of measurement, each period of measurement being 16 hours, 14 hours, 12 hours, 10 hours, 8 hours, one night, or less. This can help avoid complicating factors such as short-term thermal effects that may otherwise persist in a particularly well insulated building portion. Preferably the two periods of measurement are in a first night and the immediately following night. To enable accuracy the temperature time series data may include internal temperature time series data and external temperature time series data.

For accuracy the temperature time series data is preferably from at least one internal temperature sensor and at least one external temperature sensors. Each temperature sensor may be with a temperature sensor bias. For accuracy the temperature time series data may be from a plurality of internal temperature sensors and/or plurality of external temperature sensors.

For accuracy the method may comprise averaging the temperature time series data of a plurality of internal temperature sensors and/or averaging the temperature time series data of plurality of external temperature sensors.

For ease of processing the method may comprise dividing measurement data into a number of epochs.

For ease of processing the method may comprise evaluating each epoch to determine a power input for that epoch, an internal temperature gradient for that epoch, an internal temperature for that epoch, an external temperature for that epoch and/or an internal to external temperature difference. For accuracy the method may comprise averaging the internal temperature gradient of a plurality of internal temperature sensors, averaging the internal temperature of a plurality of internal temperature sensors and/or averaging the external temperature of a plurality of external temperature sensors.

For efficiency each epoch may be 15 minutes to 60 minutes long.

For accuracy the method may comprise determining the estimated measurement error from at least 2 epochs, and preferably at least 4 epochs, preferably from an end of a heating portion and a cooling portion. The method may comprise dividing the measurement data into a heating portion and cooling portion in dependence on whether or not power is input. The method may comprise dividing the heating portion and/or the cooling portion of the measurement data into equal sized epochs, preferably 6 to 10 equal sized epochs.

For efficiency the range of candidate heat loss coefficients may be from 0.5x to 3x the design target heat loss coefficient, or from 0.1x to 5x the design target heat loss coefficient. The range of candidate heat loss coefficients may be in increments of 0.005x the design target heat loss coefficient; 0.001x the design target heat loss coefficient; or 0.01x the design target heat loss coefficient.

For accuracy the design target heat loss coefficient preferably includes a contribution from an air change rate, preferably a measured or estimated air change rate. The method may comprise determining the design target heat loss coefficient in dependence on an air change rate.

For accuracy the temperature time series data and the power time series data are synchronised. The method may comprise synchronising the temperature time series data and the power time series data.

For clarity and user adaptability the method may comprise determining the combined sensor bias in dependence on a confidence level, optionally wherein the confidence level 90% or 95%.

Preferably the method comprises determining the combined sensor bias in dependence on a power sensor bias and a temperature sensor bias

For accuracy a maximal internal to external temperature difference may be at least 20° C., preferably at least 25° C., and more preferably at least 30° C. A minimum internal to external temperature difference may be at least 1° C., preferably at least 3° C., and more preferably at least 5° C.

Preferably the method comprises inputting power to a building portion. Preferably the method comprises heating a building portion and/or cooling a building portion.

Preferably the method comprises inputting power for a first heating/cooling period and permitting equilibration of the building portion to the environment for a second cooling/heating period. The first heating/cooling period may be a first 30-50% of an intended period of measurement and the second cooling/heating period may be a remainder of the intended period of measurement. The first heating/cooling period and/or the second cooling/heating period may be (each) between 2 and 20 hours, preferably at least 3 hours, 4 hours, 5 hours, 6 hours, 7 hours, 8 hours, half a night, one third a night, two thirds a night, or one night. The power input is preferably constant for the first heating/cooling period and/or negligible for the second cooling/heating period.

For optimal heating/cooling the power input may be determined to in dependence on a desired maximal internal to external temperature difference and/or a cut-off temperature. The power input may be determined in dependence on an intended period of measurement or a heating/cooling period or a cooling/heating period. The power input may be determined in dependence on the design target heat loss coefficient.

The method preferably comprises measuring power input to determine power time series data representing heating/cooling power input to the building portion and/or determining power sensor bias for the sensor measuring power input

The method preferably comprises forcing convection in the building portion or parts thereof, preferably with one or more fans.

The method preferably comprises measuring temperature time series data representing temperature of the interior and exterior of the building portion and/or determining temperature sensor bias for the sensor measuring temperature.

The building portion may be a building, a section of a building, a building wing, a room or a group of rooms.

The method preferably comprises determining the estimated measurement error from fitting the measurement data to power balance equations. Measurement data from at least 2 epochs, and preferably from at least 4 epochs, may be fitted, preferably with a best fit, more preferably with a least-squared error fit, to the power balance equations to estimate the estimated measurement error.

The power balance equation may follow P=K×ΔT+C×T where P is the power input, K is the heat loss coefficient, ΔT is the internal to external temperature difference, C is a heat capacity, and \dot{T} is a temperature gradient. The power balance equations may follow P−K×ΔT=(KΔn_{Tdif f_bias}−n_{power_bias})+C×T+E where P is the power input, K is the heat loss coefficient, ΔT is the internal to external temperature difference, C is a heat capacity, \dot{T} is the temperature gradient, n_{power_bias} is the bias on the power estimation, n_{Tdif f_bias} is the bias on the estimation of the temperature difference and E is a validation model error.

The method preferably comprises determining the estimated measurement error [symbol] with:

$$[ \frac{\hat{c}}{} ] = {[ \underline{1} \dot{T} ]}^{†} \times ( P - K \times Δ T )$$

where: [symbol] is the estimated measurement error; Ĉ is an estimated heat capacity; \dot{T} is a vector of temperature gradients during epochs; t is a Moore-Penrose pseudo-inverse operator; P is a vector of mean heating powers during epochs; K is a candidate heat loss coefficient; ΔT is a vector of internal to external temperature differences during epochs; and 1 is a vector of all ones.

The method preferably comprises determining the combined sensor bias | [symbol] | with: | [symbol] |<CL×\sqrt{K²×σ_{TD}²+σ_{pow}²} where: | [symbol] | is the combined sensor bias; σ_{TD} is a sensor error for internal to external temperature difference; σ_{pow} is a sensor error for heating power; K is a candidate heat loss coefficient; and CL is a confidence level factor, preferably 1.6449 for a 90% confidence lever or 1.96 for a 95% confidence level or 1.44 for an 85% confidence level.

The method preferably comprises determining the sensor error for internal to external temperature difference with:

$${σ}_{T D}^{2} = \sqrt{\frac{{σ}_{in}^{2}}{{n}_{in}} + \frac{{σ}_{e x t}^{2}}{{n}_{e x t}}}$$

where: σᵢₙ is a sensor error for an internal temperature sensor; nᵢₙ is a number of internal temperature sensors; σₑₓₜ is a sensor error for an external temperature sensor; and nₑₓₜ is a number of external temperature sensors.

According to another aspect there is provided apparatus for validating whether a building portion has a design target heat loss coefficient, comprising: a module adapted to determine a plausible range of heat loss coefficients in which an estimated measurement error does not exceed a combined sensor bias; and a module adapted to provide an indication of whether the design target heat loss coefficient is validated depending on whether or not the design target heat loss coefficient is inside the plausible range of heat loss coefficients.

Apparatus may further comprise one or more modules adapted to perform one or more methods as aforementioned. Apparatus may be adapted to perform one or more methods as aforementioned.

According to another aspect there is provided a system comprising apparatus as aforementioned and one or more of: a plurality of temperature sensors; one or more heaters or coolers; one or more fans; one or more power meters; and a clock.

According to another aspect there is provided a computer program product comprising software code adapted to perform, when executed, the steps of: determining a plausible range of heat loss coefficients in which an estimated measurement error does not exceed a combined sensor bias; and providing an indication of whether the design target heat loss coefficient is validated depending on whether or not the design target heat loss coefficient is inside the plausible range of heat loss coefficients.

The computer program product may be adapted to perform one or more methods as aforementioned.

According to another aspect there is provided a method of heating or cooling a building portion, comprising determining a power input to the building portion in dependence on one or more of: a design target heat loss coefficient, a desired maximal internal to external temperature difference, a cut-off temperature, an intended period of measurement, and a heating/cooling period. The heating/cooling period may be a predetermined portion of the intended period of measurement, for example 30-50%.

The method may comprise determining the power input in dependence on a design target heat loss coefficient such that the building portion reaches the cut-off temperature and/or the desired maximal internal to external temperature difference at the end of the heating/cooling period. The heating/cooling period may be between 2 and 20 hours, preferably at least 3 hours, 4 hours, 5 hours, 6 hours, 7 hours, 8 hours, half a night, one third a night, two thirds a night, or one night. The power input may be constant during the heating/cooling period. The cut-off temperature may be 5° C., 10° C., 40° C., 45° C., 50° C., 55° C. or 60° C.

Any method feature as described herein may also be provided as an apparatus feature, and vice versa.

Any feature in one aspect may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

As used herein, means plus function features may be expressed alternatively in terms of their corresponding structure, such as a suitably programmed processor and associated memory.

These and other aspects of the present invention will become apparent from the following exemplary embodiments that are described with reference to the following figures in which:

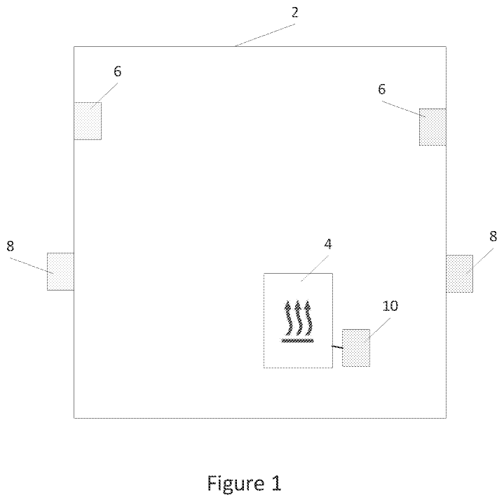

FIG. 1 is a schematic of an arrangement for testing the thermal performance of a building;

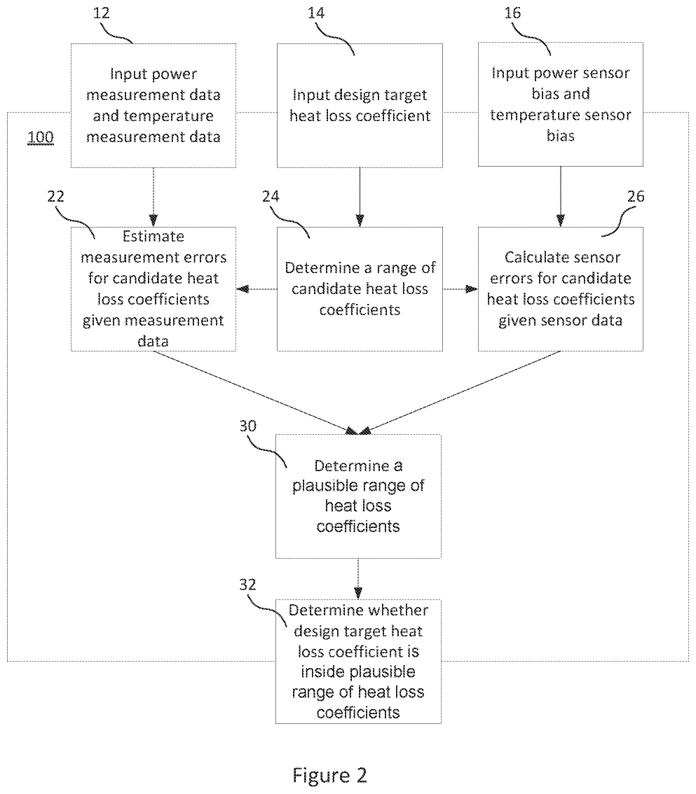

FIG. 2 is a schematic of a device for testing the thermal performance of a building;

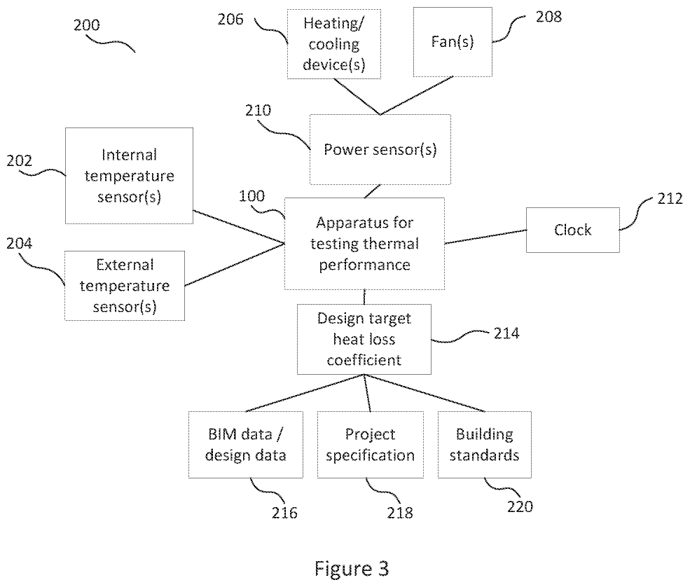

FIG. 3 is a schematic of a system for testing the thermal performance of a building;

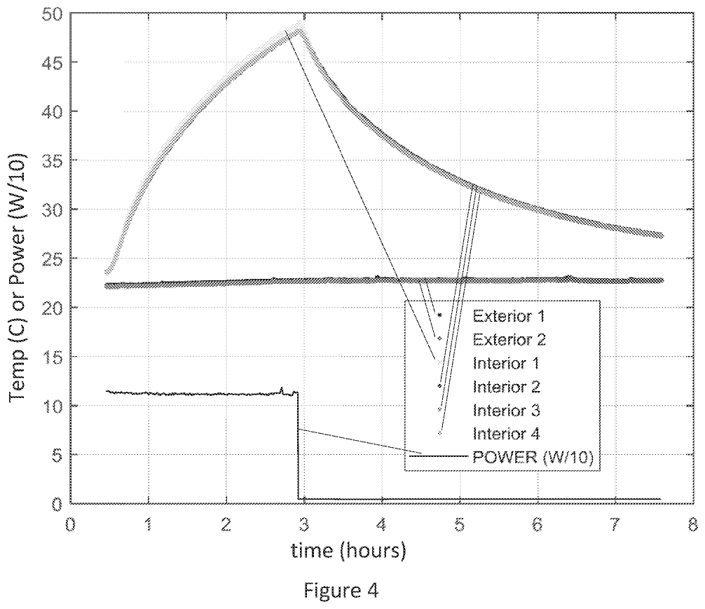

FIG. 4 is a graph of temperature and power measurements against time;

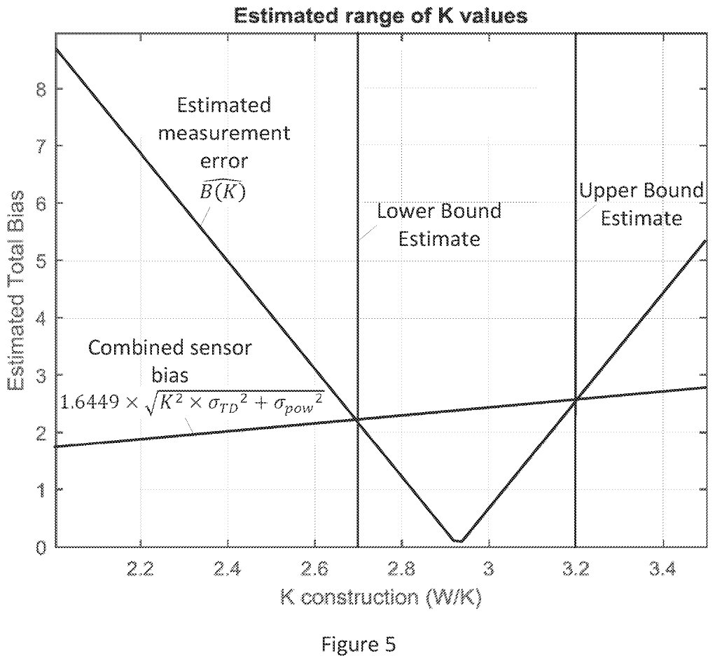

FIG. 5 is a graph of error estimates against candidate K values from measurement data and from sensor date; and

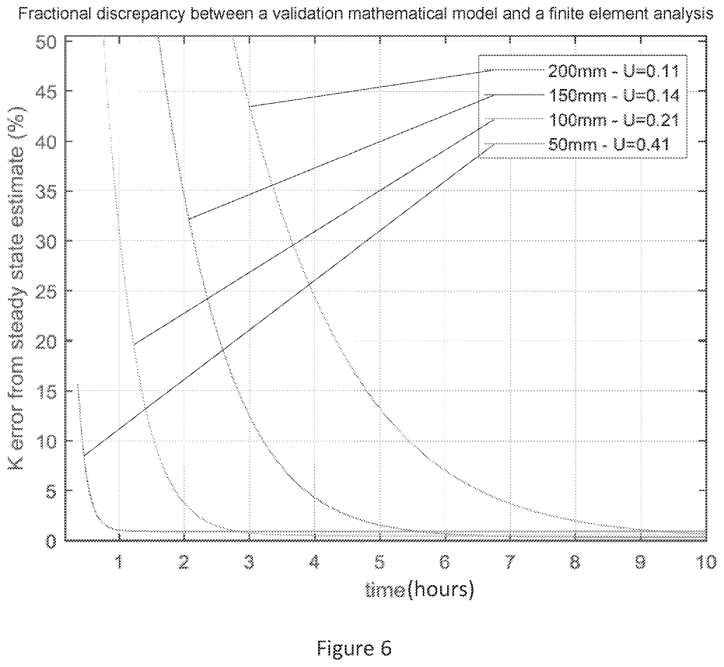

FIG. 6 is a graph of fractional discrepancy between a validation mathematical model and a finite element analysis.

FIG. 1 shows a building 2 that is undergoing testing of whether its thermal performance is consistent with its design data. An expected heat loss coefficient is calculated, from e.g. design data, which might be found in building information modelling (BIM) data (or similar design model data), project specifications or building standards. Then the building is heated, for example with a heater 4, for a few hours, and subsequently left to cool passively, while measuring air temperatures inside and outside the building with suitable internal temperature sensors 6 and external temperature sensors 8. Finally the collected data is tested as to whether it is consistent with the expected heat loss coefficient. A range of candidate heat loss coefficients are considered and for each candidate heat loss coefficient a measurement error is estimated for the given measurement data. Additionally, for each candidate heat loss coefficient a sensor error is calculated for the given sensors. By comparing the estimated measurement errors and the calculated sensor errors a range of candidate heat loss coefficients can be determined that are plausible. If the expected heat loss coefficient is within the plausible range then the measurements are consistent with the expected heat loss coefficient. If the expected heat loss coefficient is outside the plausible range then the measurements are not consistent with the expected heat loss coefficient, and the anomaly can be checked further. A confidence level, for example 90%, is associated with the plausible range.

The method may for example be used at the end of construction, to check for anomalies which may include data input errors in the design stage, use of inferior building materials to those specified, or inferior workmanship leading to air gaps, thermal bridges or other flaws. These could affect the environmental impact and the running costs of the building.

Determining if a building has the thermal performance that is specified by its design data can ensure compliance with design at the hand-off between construction and management of a building. In another example the thermal performance can be assessed to check the effect of a major re-fit or to detect unauthorised modifications.

There is a desire to predict the whole-life cost and environmental impact of buildings, including energy running costs. However, both energy costs and environmental impact are critically dependent upon the quality of the construction. A significant impact can be caused by, e.g. errors in the design stage, use of inferior building materials to those specified, or inferior workmanship leading to air gaps, thermal bridges or other flaws.

The thermal validation process described herein is intended to enable checking that the thermal performance of a building is in line with the design data for the building. The thermal validation process consists of applying heating power to the building over a period of time, measuring its thermal response, and comparing the response to what is expected based on the design data.

FIG. 2 shows a schematic of a device 100 for testing the thermal performance of a building. The device 100 receives the following inputs:
power measurement data and temperature measurement data 12
design target heat loss coefficient 14
power sensor bias and temperature sensor bias 16

The device 100 determines 24 a range of candidate heat loss coefficients 24 from the design target heat loss coefficient. The device 100 estimates 22 measurement errors for candidate heat loss coefficients given the measurement data. The device 100 calculates 26 sensor errors for candidate heat loss coefficients given the sensor bias data. The device 100 determines 30 a plausible range of heat loss coefficients. The device 100 determines 32 whether the design target heat loss coefficient is inside the plausible range of heat loss coefficients and provides an output indicating whether the measurement data is consistent with the design target heat loss coefficient.

FIG. 3 shows a schematic of a system 200 for testing the thermal performance of a building. A device 100 for testing the thermal performance of a building receives data from internal 202 and external 204 temperature sensor(s). A power meter 201 provides data regarding power used by heating/cooling devices 206 and optionally fan(s) 208. A clock 212 for synchronisation of the data is provided. A design target heat loss coefficient 214 is provided, for example from a building information model (BIM) 214 or a similar design model, from a project specification 218, from a relevant building standard 220, or similar.

The thermal performance of a building, portion of a building or room within a building is compared to an expected or required thermal performance. The method includes:

1. Forming a hypothesis about the thermal performance of the building, portion of a building or room. This can be done by analysing data from a model or specification of the building, which may be electronic, e.g. building information model (BIM), using measurements of other similar buildings, portions of a building or rooms, using measurements of the building, portion of a building or room taken at a previous time or using regulatory requirements for the building, portion of a building or room.

2. Applying a known amount of heating or cooling to building, portion of a building or room by an appropriate method such as (but not limited to) electric space heating, gas heating or air conditioners/heat pumps. The heat or cooling may be applied according to various profiles, such as ‘on’ for a given time, modulated as an on/off cycle or according to more complex rules.

3. Recording the temperature, heating or cooling power and other environmental parameters within said building, portion of a building or room, and also externally to the building and in other places within the building. These places could be, for example, on external walls, on partition walls, floors, ceilings, or beside walls, or a combination.

4. Analysing the temperature (and other sensor readings) to assess whether the thermal performance of the building, portion of a building or room is consistent with the hypothesised performance.

5. Using the temperature (and other sensor readings), together with information about the accuracy of the sensors and other sources of error, to calculate confidence or credible intervals for thermal parameters of interest.

Importantly, the present method does not aim to measure a heat loss coefficient. Instead the present method determines a range of plausible candidate heat loss coefficients, without providing any further detail as to whether any particular one of those plausible candidate heat loss coefficients is more likely than another. The present method determines if a design heat loss coefficient is consistent with measurements, without determining an actual measured heat loss coefficient. The crucial question is not what the precise actual heat loss coefficient is for a building, but instead whether or not the building is consistent with a design heat loss coefficient. The present method addresses the latter question without necessarily providing an answer to the former. The thermal mass of the building does not need to be known.

In order to measure a heat loss coefficient accurately for well-insulated buildings relatively long measurement periods are required, typically several days, for example 2-7 days or more. The mathematical models governing the thermal relationships used for validation can become relatively complex for such extended time periods, for example due to the influence of solar heating, humidity or weather effects—this again can affect the accuracy with which the heat loss coefficient can be determined. During the measurement period human interference with the building can affect the measurements; limiting human interference with the building over an extended period of several days to avoid affecting the measurements can be challenging, expensive and generally undesirable. The present method permits measurement over a relatively short period (typically one night, potentially extended to a second following night), giving a simple, cost-efficient, and viable approach. The present method can enable relatively simple and effective validation of whether a building meets the thermal performance predicted from the design information (e.g. BIM data).

Many factors contribute to the thermal response of a building. The following table sets out a number of such factors, and whether the experimental conditions are selected such that their impact is avoided, whether their impact is accommodated in the mathematical models used for validation (power balance equations) used for assessing the experimental data, or whether their impact is considered negligible and they are ignored.

| | Approach to | |
|---|---|---|
| | handling this | |
| Factor | factor | Notes |
| Long-term | Accommodated | This is the key behaviour to investigate |
| thermal | | |
| characteristics | | |
| Short-term | Avoided | Avoided by using data from near the |
| thermal | | end of a long period of constant |
| characteristics | | heating |
| Solar heating | Avoided | Experiment at night to avoid |
| Air loss | Accommodated | Measure or estimate air change rate and |
| | | incorporate into the analysis |
| Thermal mass | Accommodated | Include wide range of possibilities |
| Heating power | Accommodated | Power measurement can be carried out |
| measurement | | in many ways with different |
| error | | performance characteristics |
| Temperature | Accommodated | Use sensors with known characteristics. |
| measurement | | Aim to approach a stirred-box |
| error | | behaviour as much as possible (e.g. |
| | | use of fans to mix air) |
| Wind | Complex (see | Effects on air change can be |
| (increasing | discussion | accommodated. Avoid consistent |
| air change) | below) | wind speeds >10 mph |
| Varying | Complex (see | Slowly varying external temperatures |
| External | discussion | can be accommodated. Avoid rapid |
| Temperatures | below) | changes after the first hour of |
| | | heating |
| Varying | Ignore | The effect of humidity is small unless it |
| Humidity | | is directly reducing the effectiveness |
| | | of the insulation, which would be |
| | | measured as an insulation failure |
| Precipitation | Complex (see | Avoid driving rain/precipitation (see |
| | discussion | wind). Include other effects (inverted |
| | below) | roofs) in the analysis |

Wind: There are two main effects of high windspeeds. Firstly, they can increase air change rate (air flows between the interior and exterior of the building), especially for passively ventilated buildings—if this can be accommodated in an air change loss contribution to the design target heat loss coefficient. Secondly, it increases the heat loss through the skin of the building. Unless the insulation is very poor this is likely to be a relatively small effect for lower (<10mph) wind speeds. Avoiding higher wind speeds means that deviations from the design target thermal characteristics can be attributed to construction errors rather than the wind effects.

External Temperatures: To get a good measurement of the long-term thermal characteristics of the building, the external temperatures need to be stable compared to the temperature difference achieved by the heating. As the temperature difference is likely to reach 30 degrees or more, variations of 3 degrees in the external temperature can be accommodated. In addition, more significant changes to the external temperatures can be accommodated if they occur only during the first hour or so of heating—so an initial temperature drop at the start of the night is not a problem.

Precipitation & Humidity: Have small effects on the thermal characteristics unless:
the insulation material is damaged by it (which would be detected as a defect),
it is accompanied with high wind speeds or driving rain (which are avoided, see above), or
specific components are directly affected. For example, inverted roofs have differing expected thermal characteristics in the wet and dry, so the design target to compare against should include the appropriate value for the test conditions.

Several of these complicating factors (wind, varying external temperatures, short term thermal characteristics) are impossible to eliminate completely from any experiment. This means that increasing the accuracy of other parts of the experiment (e.g. by using highly accurate temperature sensors) cannot improve the performance beyond a limit created by these unavoidable complicating factors.

The thermal validation process can be split into three main stages: preparation, measurement, and validation calculations.
1. Preparation: The preparation stage consists of preliminary calculations and planning the measurements to be carried out. This includes estimating the design target heat loss coefficient and a suitable heating power; selecting heating hardware, a means of measuring power delivered, and temperature sensors; and determining whether the confidence interval the equipment can give is narrow enough or whether more accurate equipment is required.
2. Measurement: heat the building and then leave it to cool; measure the heating power applied to the building and the temperature inside and outside the building throughout.
3. Validation calculations: The validation calculations produce a range of plausible heat loss coefficients for the building that are consistent with the measured data and the measurement hardware. This range is compared with the building's design data or relevant building standards.

These three stages are now described in more detail

The preparation stage includes following steps:
Determine the ‘design target’ heat loss coefficient
   Heat exchange by air flow
Determine heating methodology
   Heating power
   Heating method
   Precision of heating measurement
Determine temperature measurement
   Temperature measurement system
   Synchronisation
   Precision of temperature measurements

Calculate the ‘design target’ heat loss coefficient: a ‘design target’ heat loss coefficient is calculated from BIM or similar design model, project specifications, relevant building standards or similar. In equations this value is referred to as K_{DT}, with units of W/K.

The design target heat loss coefficient is used in two ways:
To help determine what heating power should be applied
To analyse the output of the experiment—the purpose of the experiment is to see if the building's thermal behaviour is consistent with the design target.

The value of K _{DT} may be obtained by several potential methods. If the heat loss coefficient for the building is available in existing BIM software, this can be used, however for complex buildings this value is unlikely to be of use in the BIM software and so may not be available.

The next simplest method of determining K_{DT} is to use the data for all external surfaces which can be extracted e.g. from BIM or similar design model. For each external surface, the U-value (units of W/Km2) can be multiplied by the surface area to determine the heat loss coefficient for that surface. These can then be added together to calculate K_{DT}. This may be simple to carry out in some BIM software, but if the data for each construction needs to be extracted by hand it might be time-consuming and error-prone. A possible solution is to develop a plugin that extracts and aggregates U-values and surface areas from existing BIM software.

One more option is to use existing simulation software to simulate long-term constant heating in a stable environment (with confounding factors such as wind, solar load etc. omitted from the analysis) and use the simulation results to estimate K_{DT}, just as one might estimate a heat loss coefficient from experimental results.

The value of K_{DT} should include allowance for the expected air flows, based on design data, between the interior and exterior of the building. Air change rates are typically measured in units of air changes per hour, abbreviated ‘ach’. The air change rate is referred to with a. The contribution of air change to the heat loss coefficient may be calculated as

$${K}_{a i r} = 1005 \times \frac{a}{3600} \times v \times 1.225$$

Here v is the air volume of the building, which is to be estimated from the design data. The three constant values are the specific heat capacity of air (1005 J/kg), the density of air (1.225 kg/m3), and the number of seconds in an hour (3600). The specific heat capacity and density of air do vary with humidity and temperature, but these variations are small enough to be ignored.

If the value of a is not available from an air test, a generic value in line with the relevant building standards (e.g. 0.1ach for a modern building) may be used.

Determine heating methodology: once the value of K_{DT} has been determined, the heating protocol and hardware can be selected. To determine appropriate heating power 4 the significant criteria are:
Heat to reach a high temperature difference: the sensitivity of the approach is better for higher temperature differences between the inside and outside of the building at the peak of the heating. The experiment may be limited to running over a single night (to minimise the impact of solar heating as set out above), in which case the total duration available is limited. In a variant suitable for extremely well-insulated buildings the heating is carried out over one night and a cooling section is carried out over another night. In this case the duration available for heating is the whole night. Changing the peak temperature differences has an effect on the size of errors in heat loss coefficient that can be detected—a peak difference of at least 20 degrees should be obtained, and 30 or more is preferable.
Not too high: the maximum temperature reached in the experiment may be limited by safety considerations (e.g. a 55° C. thermal cut-out). If this safety limit is reached too quickly, the results may be dominated by short-term thermal effects which are not of interest. For well insulated buildings at least 4 hours of heating may be necessary. Ideally, the maximum temperature should be reached around the middle of the experiment period; the design target K_{DT} and an estimate of any additional significant thermal mass in the building should be used to calculate the heating power that would be required to achieve this.

In combination with determining an appropriate heating power, the means by which this is to be achieved needs to be determined. The key requirements are:
a roughly constant heating power needs to be applied over the heating duration (or until a pre-set thermal cut-off limit),
the power needs to be measured, and
the air temperature needs to be kept uniform throughout the building.

Here ‘roughly constant heating power’ means that during the (multi-hour) heating phase, the mean power over any 15-minute period is approximately the same: high-frequency oscillation does not matter. For example, a 10 kW heater with a 50% duty cycle, switching on or off every 30 seconds, would be acceptable as a 5 kW heater. While it is important that the heating power is roughly constant over the heating period, and that the power can be measured, it is not important that a specific power value is exactly achieved.

The two main approaches are:
Use the building's heating system. Check that constant heating power is achievable. Measuring the power may be an issue.
Use separate heating units. Ensuring that the heat is evenly spread may be an issue.

In either case, additional fans may be used to stir the air in the building and keep the air temperature approximately uniform within the building. These fans also generate some heat, and it may be necessary to include this extra heating power in calculations. The distribution of heaters and fans in different rooms of a building can be varied considerably, provided an approximately uniform air temperature within the building is produced.

Once the level and method of heating are decided, it is then necessary to estimate the likely error in the heating power. Ideally this is estimated as a standard deviation, which is referred to herein as σ_{pow}. As power readings are averaged over a long period of time, the error of interest is not the thermal noise of the measurement, but the unknown bias on it.
If separate heating (and fan) units are used power meters 8 can be used to estimate the power they are using—this compensates for unknown voltages etc. The precision is then determined by the precision of the power measurement units.
If the building's heating system is used, especially if set to a fixed power output, then the precision depends on that system.

Define temperature measurement: the temperature needs to be measured both inside and outside the building. The quality of this measurement determines in large part the potential sensitivity of the validation process. The temperature measurements are averaged over reasonably long time-periods (at least 15 minutes long). This means that the thermal noise of a sensor is not significant—only the potential sensor bias is significant, so a measurement system with low bias is favourable.

Both external and internal temperature measurements are required. The air in building is unlikely to be perfectly stirred, so it is preferable to measure the interior temperature in several places (e.g. on external walls, on partition walls, floors, ceilings, or inside the volume of a room) and use the average of these. The exterior temperature may also benefit from the use of a few sensors reading on different aspects of the exterior to reduce the potential biases.

Options for temperature sensing include:
Wired sensors—using a set of temperature sensors wired back to a control board.
Wireless sensors—with either a real-time or after-the-fact download of the logged data.
Third party measurements—e.g. using data from a meteorological office for the exterior temperature, or data from building systems for interior temperatures.

All temperature and power measurement devices log timestamped data and their clocks are synchronised to within one minute.

Once the methods of measuring the temperature are set, it is then necessary to estimate a suitable range of bias error in the measurement of the temperature difference between the interior and exterior of the building. The temperature difference is expressed as follows:

T_{D}=Tᵢₙ+Tₑₓₜ

The estimate of the bias should be expressed as a standard deviation, σ_{TD} Assuming that internal and external temperature measurement errors are uncorrelated:

σ_{TD}²=σᵢₙ²+σₑₓₜ²

Based on the mathematical equations governing the thermal relationships (the power balance equations described in more detail below), the error of measurement data can be estimated (e.g. with a best fit of measurement date to mathematical equations) for a range of candidate heat loss coefficients. This can then be compared to the error introduced by the combined sensor bias. The comparison yields plausible heat loss coefficients where the estimated measurement error is consistent with the combined sensor bias. This is discussed in more depth below.

Now the measurement stage is described in more detail. Usually the measurements are collected over a single night, to remove the effects of solar load from the power balance equations, as discussed above. During this period the heating is on, at a constant power, for the first 30-50% of the time. The interior and exterior temperatures are logged over the entire duration. Fans may be used to mix the air inside the building and achieve roughly constant temperatures throughout the building.

When the heating has raised the temperature to a pre-ordained thermal cut-off value or a pre-ordained time after it started (whichever comes first) the heating is switched off and the building is left to cool at its natural rate.

It is important that enough data is collected for the processing before the sun starts to produce solar heating on the building and on the sensors directly—any data collected after this is ignored.

An ideal night for data collection is long, cold, and still. The building is in as air-tight a configuration as possible (or as close as possible to the known configuration used in the air-tightness test). Once the experiment is started the building is to remain unmodified (e.g. no opening of doors) for the duration.

If a building is very well insulated the short-term thermal characteristics may have a significant effect over a half night. In this case a similar procedure can be used where two nights are used—the first night being entirely dedicated to heating and the second night to cooling. In the first night the building is heated as described above, but using a heating power calculated such that the thermal cut-off is reached near the end of the night. Prior to the second night heating is applied during the foregoing day to ensure a high interior temperature is obtained at the start of the second night. This building is then left to cool for the entire night, analogous as described above.

Now the validation calculations are described in more detail.

To determine if a building's thermal performance is consistent with its design data, a range of candidate values of K is considered. For each candidate values of K it is calculated what the sensor biases would need to be to account for the data if that were the true value of K. If the sensor biases would have to be large, then that value of K is deemed implausible. The result of applying this reasoning to many different values of K is a range of plausible K values that are consistent with the measurements. If Kin- is not in the range of plausible K values, then the building's thermal performance is not consistent with design data. More detailed conclusions can be made, such as ‘the heat loss coefficient is 20-40% greater than it should be’. This is a hypothesis-testing approach for validation calculations, where the hypothesis is that the heat loss coefficient is a particular value, which (given the measurement data) implies that there is an implied error in the sensor measurements. Given the actual sensor error is known, the implied error may or may not be plausible—in which case the assumed heat loss coefficient is or is not consistent with the experimental data.

The calculation is performed in three stages:
Split the measured data into a series of epochs. Calculate summary power and temperature statistics for each epoch, and select a subset of epochs for further calculation.
For each candidate value of K, calculate the best fit of the power-balance equations to estimate the corresponding measurement errors
Compare the estimated measurement errors to the known combined sensor biases characteristic of the sensors to determine whether the candidate K value is consistent with the data

The data is split into a series of time periods (epochs). Summary statistics are calculated for each epoch, and a few epochs are selected to be used for further calculation.

Each epoch is between 15 minutes and an hour long to ensure that a couple of epochs can be observed at the end of the heating and cooling segments, with enough time before these to ensure the avoidance of short-time scale transient thermal effects.

The end of the heating phase may correspond exactly to the end of an epoch. The duration of the heating phase may be split up into 6-10 equal size epochs, and then use this size for the cooling phase (potentially discarding a small quantity of data at the end of the cooling phase).

In each epoch, indexed by k, summary statistics are determined as follows:
The temperature at each sensor, indexed by i, at the middle of the epoch, T_{i,k}
The rate of temperature change at each sensor, at the middle of the epoch,

$$\frac{\partial {T}_{i , k}}{\partial t}$$

The mean applied heating power during the epoch, Pₖ

A variety of linear regression methods (such as can be found in scientific software packages such as SciPy or MATLAB) can be used to compute Tᵢ, and

$$\frac{\partial {T}_{i , k}}{\partial t}$$

from me raw data. One advantage of using the linear approach for this is that it allows the residual error (RMSE) to be calculated if needed—this is a metric of the data fit and could be used to validate if the data in a given epoch was of high enough quality to allow the subsequent use of the epoch. Once Tᵢ, and

$$\frac{\partial {T}_{i , k}}{\partial t}$$

are calculated for each sensor i, data must be aggregated over sensors by averaging over individual sensors as follows:

$${T}_{E X T , k} = \frac{1}{{N}_{E X T}} {\sum }_{i ∈ E X T} {T}_{i , k} \\ {T}_{IN , k} = \frac{1}{{N}_{IN}} {\sum }_{i ∈ IN} {T}_{i , k}$$

$${\dot{T}}_{k} = \frac{\partial {T}_{IN , k}}{\partial t} = \frac{1}{{N}_{IN}} {\sum }_{i ∈ IN} \frac{\partial {T}_{i , k}}{\partial t}$$

In these equations NIN is the number of temperature sensors used in estimating the interior temperature, and NEXT is the corresponding number for the exterior temperature. If a single temperature sensor breaks, or produces unreliable data, it can be excluded here without affecting the overall validity of the method.

Finally, the temperature difference between the interior and exterior is estimated:

ΔTₖ=T_{IN,k}−T_{EXT,k}

The three outputs for each epoch are: Pₖ, \dot{T}ₖ and ΔTₖ

Next a set of epochs is selected for further use. As the long-term thermal properties of the building are being evaluated only those epochs from near the end of either the heating or cooling are used. At a minimum two epochs are required, but the method works better with more, e.g. four, two from each of the heating and cooling sectors. The last epochs in each sector are preferred. An epoch may be ignored if the calculation of summary statistics for the temperature or power suggest that the data for this epoch is unreliable (this is probably a sign that a problem has occurred in the experiment and the whole test is unreliable, e.g. someone opened a door near the peak of the heating section). An epoch may be ignored if the temperature difference between the inside and outside is too low, that is if ΔTₖ is less than a set level (e.g. about 3° C.). In this case the utility of subsequent epochs (in the cooling section) declines, especially as estimating the temperature gradient accurately enough becomes difficult. In this case taking the epochs from just before the set level is reached is preferred.

Other sets of epochs, e.g. from just the end of the heating curve, may be used and still obtain useful results. The suggestions above are designed to obtain a good level of sensitivity from the experiment.

The epochs chosen are denoted by k₁, k₂, . . . kₙ.

For each heat loss coefficient value, the experimental data is fit to power-balance equations to simultaneously estimate a thermal mass C and a combined sensor bias term [symbol] . The sensor bias term is then compared to a bound derived from the sensor characteristics. If the sensor bias term is large that value of heat loss coefficient K is not consistent with the experimental data. The implication is that either the heat loss coefficient is not the assumed value or the sensor biases are much higher than expected given the sensor characteristics.

Next candidate values for heat loss coefficient are selected. A range of potential heat loss coefficient values, K, are tested for consistency with the experimental data. A suitable range of potential heat loss coefficient values, K, can be found by ranging from 0.5×K_{DT} to 3×K_{DT} in steps of 0.005×K_{DT} giving at least 501 different values to consider. This would be impossibly tedious to do by hand, but almost instantaneous on a standard laptop PC.

Next the power balance equations are established for chosen set of epochs. When constant heating is applied, the following power-balance equation holds with good accuracy after enough time has passed to ensure that short-term thermal transients can safely be ignored (for example about 4 hours may be sufficient):

Pₖ=K×ΔTₖ+C×\dot{T}ₖ [1]

In the equation above,
Pₖ is the mean heating power during epoch k with units W.
K is a heat loss coefficient with units W/° K. The value of K includes heat loss due to air exchange as well as heat loss through the fabric of the building.
ΔTₖ is the temperature difference between inside and outside at the middle of epoch k, with units ° K
C is a heat capacity, with units J/° K
\dot{T} is the rate of heating (also referred to as the temperature gradient), with units ° K/s

The measurements for all epochs being used in the calculation can be combined using matrix-vector notation so that the power balance equation for all epochs becomes:

P=K×ΔT+C×\dot{T} [1]

where P, ΔT, and \dot{T} are all vectors formed by stacking the corresponding values for each of the epochs being used, e.g.:

$$P = [ \begin{matrix}{P}_{{k}_{ 1}} \\ {P}_{{k}_{ 2}} \\ {P}_{{k}_{ 3}} \\ {P}_{{k}_{ 4}}\end{matrix} ]$$

The above power balance equation [1] has been used extensively in the literature, including studies of how long a period of constant heating power is needed before it becomes valid. The version of equation [1] with exactly two measurement epochs is used as a key part of many methods for measuring the value of K. In such approaches, P, ΔT, and \dot{T} are measured in two epochs and an exact solution for K and C is calculated; usually C is treated as a nuisance parameter. However, such exact calculations can be highly sensitive to measurement errors on P, ΔT, and \dot{T}. A better approach is to extend the power balance equation [1] by explicitly incorporating sensor errors.

Next measurement errors are incorporate into the power balance equations. Equation [1] does not have an exact solution due to two distinct classes of error:
Measurement errors in the measurements of the values in P, ΔT, and \dot{T}. As the duration of each epoch contains many different measurements, the summary statistics obtained by combining these have very little thermal sensor noise, so these errors are dominated by sensor biases in P and ΔT.
Validation model errors due to violations of the assumptions necessary to establish the power balance equations. The mathematical equations assumed to govern the thermal relationships (notably the power balance equations) do not fully match the reality. Validation model errors reflect the discrepancy between the actual behaviour and the behaviour described by the mathematical model used for the validation. The major error would be if early epochs were used, in which case the short-term thermal characteristics would mean each epoch has different apparent K and C values, so the vector equation no longer holds. Other validation model errors include missing heat sources (such as solar load) and any changes in the experiment set-up during the experiment.

If the validation model errors are assumed to be small then bias error terms and general validation model errors can be incorporate into the power balance equation—noting that bias errors apply identical effects in each epoch. This leads to the expanded power-balance equation:

P+n_{power_bias}×1=K×(ΔT+n_{Tdif f_bias}×1)+C×\dot{T}+E [2]

where 1 is used to denote a vector of all ones, n_{power-bias} is the bias on the power estimation, n_{Tdif f_bias} is the bias on the estimation of the temperature difference and E is a vector of validation model errors.

This can be rearranged placing all the terms which are completely determined by measurements and assumed heat loss coefficients are on the left hand side, and placing two terms determined by unknown single values, C and a combination of the bias terms, on the right hand side.

P−K×(ΔT)=(K×n_{Tdif f_bias}−n_{power-bias})×1+C×\dot{T}+E

The notation is simplified by using the following two substitutions, B(K) is used to denote the combined bias term (which varies with K) and Pᵤₙ is used to denote the unattributed power, i.e. the power not attributed to heat loss through the heat-loss coefficient.

B(K)=(K×n_{Tdif f_bias}−n_{power_bias}) Pᵤₙ=(P−K×ΔT)

The power balance equation then simply becomes:

Pᵤₙ=B(K)×1+C×\dot{T}+E

This can be further simplified by combining all of the known terms into a single matrix:

$${P}_{u n} = [ \begin{matrix}\underline{1} & \dot{T}\end{matrix} ] \times [ \begin{matrix}C \\ B ( K )\end{matrix} ] + E \qquad [ 3 ]$$

Next the fit of power balance equations is calculated for a given heat loss coefficient. A best fit solution (i.e. values of C and B(K)) to equation [2] can be determined for a given heat loss coefficient. This is done by solving the vector power-balance equation, [3] in a least-squared error sense to minimise the power of E (using the Moore-Penrose pseudo-inverse, denoted by a † operator) to simultaneously determine an estimate of the effective thermal mass of the building, Ĉ, and an estimate of the combined biases, [symbol] .

$$[ \begin{matrix}\hat{C} \\ \end{matrix} ] = {( {[ \begin{matrix}\underline{1} & \dot{T}\end{matrix} ]}^{T} \times [ \begin{matrix}\underline{1} & \dot{T}\end{matrix} ] )}^{- 1} \times {[ \begin{matrix}\underline{1} & \dot{T}\end{matrix} ]}^{T} \times {P}_{un} = {[ \begin{matrix}\underline{1} & \dot{T}\end{matrix} ]}^{†} \times {P}_{un} [ \begin{matrix}\hat{C} \\ \end{matrix} ] = {[ \begin{matrix}\underline{1} & \dot{T}\end{matrix} ]}^{†} \times ( P - K \times Δ T )$$

The vector equation represents one equation for each epoch with the knowns P, ΔT, and \dot{T}, and each equation contains the same two unknowns C and B(K). A solution leading to a perfect fit to the data could be found if exactly two epochs were used. However, this approach effectively ignores data from all other epochs, and so tends to lead to less robust solutions which can have significant errors if the data from one epoch is poor. The use of the pseudo-inverse is a suitable technique for finding a best fit solution to a set of over-determined equations such as the set of equations for each epoch described above.

ΣᵢÊᵢ² provides an estimate of the discrepancy between validation model and reality. This could be used to detect when the experiment as carried out does not appear to fit the validation model (e.g. short-term thermal characteristics remain, broken sensors used, unmeasured heat sources).

The estimate of the combined biases, [symbol] , is now compared to the expected variability of the sensor bias. This provides a plausible range for the heat loss coefficient K. The absolute estimate of the combined bias term | [symbol] | is compared to the expected variability of the sensor bias.

Several ways of carrying out this comparison are possible. One option would be to use sensor performance specification data that provides absolute bounds on the bias terms for the sensors (as might be produced if the sensors are manufactured, tested for bias and those outside the stated range are not sold). Another option is to assume a standard

Gaussian distribution for the basis terms on the basis of the performance specification giving a 95% performance bound.

In this latter case it is assumed that the specified bias terms have the following standard deviations:
n_{power_bias} has assumed standard deviation of σ_{pow}
n_{Tdif f_bias} has assumed standard deviation σ_{TD}

This leads to the B(K) having an assumed standard deviation of \sqrt{K²×σ_{TD}²+σ_{pow}²}

In an example a 90% confidence interval is used for this combines sensor bias term—hence the heat loss coefficient is considered consistent with the data if:

| [symbol] |<1.6449×\sqrt{K²×σ_{TD}²+σ_{pow}²}

Other comparisons are possible—for example if a higher number than 1.6449 is used (e.g. 1.96 for a 95% confidence level) then more values for the heat loss coefficient are considered consistent, leading to a test which is less sensitive but has a lower rate of false positive returns.

The result of the calculations above is a range of plausible values of K given the data. If the design target K_{DT} is below this plausible range, then the experiment has produced significant evidence that the building loses heat faster than the design data implies.

Finally, as the calculations above include an estimation of the thermal mass, some K values could be considered implausible if they led to implausible (e.g. negative) values for Ĉ. This is unlikely to occur without the combined bias term also being implausible.

FIG. 2 shows a graph of temperature and power measurement data for an example. In this example a 1.275m³ box of 75 mm EcoTherm PIR insulation board has some added thermal mass inside the box. FIG. 2 shows the temperature and power data logged during the experiment. The sensors Exterior 1 and Exterior 2 are roughly in agreement, as are the sensors Interior 1, Interior 2 and Interior 3. The sensor Interior 4 gives slightly higher readings than the other three interior sensors, and its data is discarded. The sensors all produce fairly smooth data so it is assumed that bias errors dominate. The bias on the power sensors is estimated to be σ_{pow}=0.5. The data sheet value for bias for the temperature sensors is +-0.5. The bias on the temperature difference (produced by differencing the two exterior and three consistent interior sensors) is

$${σ}_{TD} = 0.5 \times \sqrt{\frac{1}{3} + \frac{1}{2}} .$$

The data was split into epochs of duration 1476s (so that there are 6 heating epochs). Only the last two heating and last two cooling epochs are used. Table 2 gives the epoch data calculated for these epochs.

TABLE 2
Epoch data for example experiment

| | Mean Exterior | Mean Interior | Grad Interior | |
|---|---|---|---|---|
| Time | Temperature | Temperature | Temperature | Mean |
| (hours) | (C.) | (C.) | (C./s) | Power |
| 2.3085 | 22.6454 | 44.8239 | 0.0017 | 109.0876 |
| 2.7195 | 22.7346 | 47.1199 | 0.0014 | 109.9200 |
| 6.8277 | 22.7338 | 28.4262 | −0.0005 | 4.4353 |
| 7.2378 | 22.7497 | 27.8228 | −0.0004 | 4.4561 |

FIG. 3 shows the total sensor bias [symbol] (the estimated measurement error), estimated using the data in Table 2, and the combined sensor bias generated from the sensor characteristics 1.6449×\sqrt{K²×σ_{TD}²+σ_{pow}²}. From the intersection of the curve for the total sensor bias [symbol] and the curve for the combined sensor bias 1.6449×\sqrt{K²×σ_{TD}²+σ_{pow}²} the lower bound estimate and upper bound estimate are found. The region of plausible heat loss coefficients lies where between the lower bound estimate and upper bound estimate, in the given example between 2.70 to 3.20. Calculation from design data for the same box produces a K_{DT} value of 2.72 assuming no thermal bridging, which is within the range of plausible heat loss coefficients and so consistent with the experimental data.

In another experiment one wall of the box is replaced with 25 mm EcoTherm PIR insulation board (instead of 75 mm EcoTherm PIR insulation board as in the example above) to represent a building with inferior building material. This gives only a 15% difference in the overall insulation performance. In this case the range of plausible heat loss coefficients does not include a K_{DT} value of 2.72 calculated from design data, and so the measurement data is not consistent with the design target heat loss coefficient. This gives evidence that the box performance is not consistent with the design specification and that further investigation is required.

There are two main reasons why, using the described method, the plausible range of heat loss coefficients may not contain the design target K_{DT}:
Building errors: This is what the method aims to detect—the building, as built, does not have the thermal characteristics implied by the design.
Validation model errors: The mathematical equations assumed to govern the thermal relationships (notably the power balance equations) do not fully match the reality. The main cause of this would be the use of data from epochs before the long-term thermal characteristics of the building dominate the heating/cooling effects. Other potential issues include unmeasured heat sources, weather effects or errors in the information used to calculate the design target K_{DT}.

To analyse the sensitivity in more depth, suppose that the true heat loss coefficient is K_{DT}+Kₑᵣᵣₒᵣ. It can be shown that for small values of Kₑᵣᵣₒᵣ, the resulting change in the estimated bias term [symbol] is:

Kₑᵣᵣₒᵣ×[1\dot{T}]^{†}×ΔT

This multiplication term works out to be approximately ⅓ of the maximum temperature difference achieved.

This change can be considered as a fraction of the correct value, and compared to the bias bound:

$${K}_{error} = α \times {K}_{D T} \\ {K}_{error} \times \frac{max ( Δ T )}{3} > 1.6449 \times \sqrt{{K}^{2} \times {σ}_{TD}^{2} + {σ}_{p o w}^{2}}$$

This gives an approximate bound (ignoring second-order effects) on the fraction of KBIM which is detectable as

$$\vert α \vert < \frac{4.935 \times \sqrt{{σ}_{TD}^{2} + \frac{{σ}_{pow}^{2}}{{K}_{DT}^{2}}}}{max ( Δ T )}$$

For the example data set described above with reference to Table 2, this gives:

$$\vert α \vert < \frac{4.935 \times 0.49}{24.5} = 0.0987 = 10 \%$$

This could be considered a typical scenario where the temperature measurement is accurately logged with dedicated sensors, the power is logged with good accuracy compared to its magnitude (e.g. ˜1% error) and a 25-degree temperature difference is achieved. In another typical scenario the temperature and power accuracy are slightly worse than this (especially exterior temperature measurements) but a higher temperature difference is achieved leading to a similar accuracy.

As set out above, in a typical scenario deviations of 10% in heat loss coefficient can be observed. This is improved by:
Increasing the maximum temperature difference between the interior and exterior of the building
Obtaining more precise measurements of both temperatures and heating power used

This shows that the following three things affect the size of deviation from the design target heat loss coefficient that the method can detect (detecting smaller deviations is better):
Increasing the precision of the temperature sensing allows smaller deviations to be detected
Increasing the precision of the power measurement allows smaller deviations to be detected
Increasing the peak temperature difference achieved allows smaller deviations to be detected

The second of these (power measurement precision) scales with K_{DT} so for a larger building (larger heat loss coefficient) this becomes relatively less significant as compared to the first.

The two sensor precisions are linked, so that increasing the precision of one gives less and less improvement if the other is not improved. Usually efficiency is reached when they both have similar precisions.

For the calculations to bound the heat loss coefficient the short-term thermal transients caused by changing the heating or cooling regime must have died away, otherwise the values estimated are too high. FIG. 4 shows fractional discrepancy between validation mathematical model and a finite element analysis of the heating curve as time progresses for a simple box built from insulating material. The simulation considers a simple box of insulation board of varying thickness and U-value. For the 100 mm curve, which is assumed to match likely building behaviour, the error due to ignoring short-term thermal transients drops below a 1% error within 3 hours.

Further analysis suggests that adding extra thermal mass inside the building increases the time taken to reach this convergence, but only by about 20-30%. However, if the heating power is increased to ensure the temperature rise is similar this effect becomes minimal.

If incorrect data has been entered into, e.g. a BIM or similar, and this was used in the calculation of K_{DT} then this technique may correctly detect that the K_{DT} value is inconsistent with the experiment. The technique is unable to determine if this is due to incorrect data entry, or correct data entry and a flaw in construction.

If a data entry error is discovered after the experiment is run, but still led to a sensible heating power being used, then the experiment need not be re-run; the analysis can be carried out with a corrected K_{DT} value using the same experimental data. The experiment is invalid only if the data entry error led to significantly low temperature difference or time of heating being achieved.

The method described above can be adapted, for example to:
Test a single zone, rather than a whole building.
Test buildings in hot climates where cooling might be used instead of heating.

Adaptation of the method to test a section of a building (rather than a whole building) is now described in more detail. The aim is still validation of the heat loss coefficient to the exterior. This may enable smaller construction errors to be detected, as they lead to a proportionally larger loss of heat for a smaller section. This must be balanced with the potentially larger loss of heat between adjacent interior sections, which may be higher if these are not insulated well or very airtight. Where sections of a building have small borders compared to their external boundary (e.g. wings of a building), this is likely a suitable approach. Where the sections have large borders compared to their exteriors (e.g. floors of a building) this is likely to be a less suitable approach given detection of excessive heat loss to the exterior is intended.

If using this methodology on a section of a building, several changes need to be made. In particular, the methodology has to compensate for both air flow and heat flow into other sections of the building, rather than to the exterior. This requires:
measuring the temperature in adjacent sections of the building, and potentially ensuring that the air in these sections is well mixed;
estimating the heat loss coefficient across the boundaries between sections; and
obtaining an estimate of the air change rate between sections.

The aim is still to validate the heat loss coefficient to the exterior—this can be done by using the above values to modify the power balance equation to remove the effect of losses into adjacent sections under the assumption that the above estimates are correct. This has an impact upon the performance of the method by reducing its effectiveness if these estimates are incorrect, in proportion to the fraction of total power loss they represent.

To determine sensible sections to test a large building is partitioned into sections which are as well insulated (thermally and for air-loss) from each other as possible. If good thermal insulation is not possible, then a boundary that can be accurately modelled in a BIM software system is preferable.

The power-balance equations can be modified to include the heat flow from the section of a building being tested to a neighbouring section as follows:

P+n_{power_bias}1=K×(ΔT+(n_{Tin_bias}−n_{Text_bias})1)+K_{sec1}×(ΔT_{sec1}+(n_{Tin_bias}−n_{Tsec1_bias})1)+C×G

Where ΔT _{sec1} is used to denote the measured temperature difference between the interior of the section being tested and an adjoining section (sec1) and K_{sec1} is used to denote the heat loss coefficient between the sections. The temperature sensor bias estimates have been split into estimates for the biases of the interior sensors (n_{Tin_bias}), exterior sensors (n_{Text_bias}) and section 1 sensors (n_{Tsec1_bias}).

The power loss into the adjoining section can be factored into the unattributed power calculation of the main method:

Pᵤₙ=(P−K×ΔT−K_{sec1}×ΔT_{sec1})

Similarly, the combined sensor bias term now includes contributions from the measurement in the adjoining section:

B(K)=(K×(n_{Tin}_{_{bias}}−n_{Text_bias})+K_{sec1}×(n_{Tin}_{_{bias}}−n_{Tsec1_bias})−n_{power_bias})

This means the bound is modified to compensate, becoming:

1.6449×\sqrt{(K+K_{sec1})²×σᵢₙ²+K²σₑₓₜ²+K_{sec1}²σ_{sec1}²+σ_{pow}²}

If K_{sec1} is small compared to K this is almost identical to the whole-building bound. However as K_{sec1} becomes large, this becomes much larger than the whole-building bound. Thus, the method becomes less useful if the thermal loss coefficient between sections is large compared to the thermal loss coefficient to the exterior of the section being studied.

In consistently hot climates, the ambient temperature may well not drop below the mid 20's (e.g. Singapore—minimum daily temperature rarely drops below 24 degrees). In this case, obtaining a temperature difference of 30 degrees involves heating the interior to temperatures sufficiently high to cause issues with overheating and damaging components or contents of the building. In this section some of the changes are discussed which could be made to utilise cooling, rather than heating in the experiment. A suitably powerful and accurately measured cooling method can provide accurate assessment.

The mathematical methodology only requires a temperature difference to be achieved and does not change if cooling is used instead of heating to obtain this difference. This means that the methodology described above is unchanged, excepting the swapping of heating for cooling.

The sensitivity analysis shows that short-term thermal characteristics consistently lead to an over-estimate of the buildings thermal coefficient when the building is heated. If the building is instead cooled the consistent errors become an underestimate of the thermal coefficient.

The main difference with using cooling is that a method of cooling (rather than heating) the building is used. The two main difficulties with cooling are:
Achieving a suitably large temperature difference between the interior and exterior of the building. A temperature difference of >20 degrees, ideally >30 degrees is desired. It may be difficult to achieve this with a building air conditioning (cooling) system. One potential approach to tackling this issue is to extend the measurement period to two nights, as discussed above.
Obtaining a reliable measurement of the cooling power achieved, as the efficiency of air conditioning systems is poorly specified and known to change with the age of the system, the temperature difference between the interior and exterior, and sometimes with the humidity of the external air.

For this approach to work the cooling power is reasonably tightly specified (when averaged over about 30 minutes). When heating, a thermal cut-off point is used. When cooling, it is more likely that the cut-off point used is a timing cut-off. It may be necessary to assess if the building fabric or its contents are susceptible to damage caused by excessive cooling—in particular with any condensation which may be caused if the dehumidification of the interior air is insufficient.

In another variant the method is adapted to compare different rooms that are expected to be similar, for example multiple rooms in a hospital.

Various other modifications will be apparent to those skilled in the art.

It will be understood that the present invention has been described above purely by way of example, and modifications of detail can be made within the scope of the invention.

Reference numerals appearing in the claims are by way of illustration only and shall have no limiting effect on the scope of the claims.

1. A method of validating whether a building portion has a design target heat loss coefficient, comprising the steps of:
determining a plausible range of heat loss coefficients in which an estimated measurement error does not exceed a combined sensor bias; and
providing an indication of whether the design target heat loss coefficient is validated depending on whether or not the design target heat loss coefficient is inside the plausible range of heat loss coefficients.

2. A method according to claim 1, further comprising one or more of the following steps:
receiving a design target heat loss coefficient;
determining a range of candidate heat loss coefficients, preferably in dependence on the design target heat loss coefficient;
receiving measurement data in the form of temperature time series data representing temperature of the interior and exterior of the building portion and/or power time series data representing heating/cooling power input to the building portion;
receiving sensor bias data for measurement data;
determining for each candidate heat loss coefficient an estimated measurement error in dependence on the measurement data; and
determining for each candidate heat loss coefficient a combined sensor bias in dependence on the sensor bias data.

3. A method according to claim 2, wherein the measurement data relate to data obtained in a period of measurement of 16 hours, 14 hours, 12 hours, 10 hours, 8 hours, one night, two nights, or less.

4. A method according to claim 2, wherein the temperature time series data includes internal temperature time series data and external temperature time series data, preferably wherein the temperature time series data is from at least one internal temperature sensor and at least one external temperature sensors, each temperature sensor with a temperature sensor bias.

5. A method according to claim 2, comprising dividing measurement data into a number of epochs and determining for each epoch one or more of: a power input, an internal temperature gradient, an internal temperature, an external temperature and an internal to external temperature difference; preferably wherein each epoch is 15 minutes to 60 minutes long; further preferably comprising determining the estimated measurement error from at least 2 epochs, and preferably at least 4 epochs, preferably from an end of a heating portion and a cooling portion.

6. (canceled)

7. (canceled)

8. A method according to claim 2, wherein the range of candidate heat loss coefficients is from 0.5x to 3x the design target heat loss coefficient, or from 0.1x to 5x the design target heat loss coefficient.

9. A method according to claims 2, wherein a maximal internal to external temperature difference is at least 20° C., preferably at least 25° C., and more preferably at least 30° C.

10. A method according to claim 2, wherein a minimum internal to external temperature difference is at least 1° C., preferably at least 3° C., and more preferably at least 5° C.

11. A method according to claim 1, wherein the design target heat loss coefficient includes a contribution from an air change rate, preferably a measured or estimated air change rate.

12. A method according to claim 1, comprising determining the combined sensor bias in dependence on a power sensor bias and a temperature sensor bias.

13. A method according to claim 1, comprising inputting power to a building portion, preferably heating a building portion or cooling a building portion.

14. A method according to claim 13, comprising inputting power for a first heating/cooling period and permitting equilibration of the building portion to the environment for a second cooling/heating period:, optionally wherein the first heating/cooling period is a first 30-50% of an intended period of measurement and the second cooling/heating period is a remainder of the intended period of measurement, further optionally wherein the first heating/cooling period and/or the second cooling/heating period is (each) between 2 and 20 hours, preferably at least 3 hours, 4 hours, 5 hours, 6 hours, 7 hours, 8 hours, half a night, one third a night, two thirds a night, or one night.

15. (canceled)

16. A method according to claim 13, comprising measuring power input to determine power time series data representing heating/cooling power input to the building portion and/or determining power sensor bias for a sensor measuring power input.

17. A method according to claim 1, comprising measuring temperature time series data representing temperature of the interior and exterior of the building portion and/or determining temperature sensor bias for a sensor measuring temperature.

18. A method according to claim 1, comprising determining the estimated measurement error from fitting measurement data to power balance equations.

19. Apparatus for validating whether a building portion has a design target heat loss coefficient, comprising:
a module adapted to determine a plausible range of heat loss coefficients in which an estimated measurement error does not exceed a combined sensor bias; and
a module adapted to provide an indication of whether the design target heat loss coefficient is validated depending on whether or not the design target heat loss coefficient is inside the plausible range of heat loss coefficients.

20. (canceled)

21. A system comprising apparatus according to claim 19 and one or more of:
a plurality of temperature sensors;
one or more heaters or coolers;
one or more fans;
one or more power meters; and
a clock.

22. A computer program product comprising software code adapted to perform, when executed, the steps of:
determining a plausible range of heat loss coefficients in which an estimated measurement error does not exceed a combined sensor bias; and
providing an indication of whether the design target heat loss coefficient is validated depending on whether or not the design target heat loss coefficient is inside the plausible range of heat loss coefficients.

23. (canceled)

24. A method of heating or cooling a building portion, comprising determining a power input to the building portion in dependence on one or more of: a design target heat loss coefficient, a desired maximal internal to external temperature difference, a cut-off temperature, an intended period of measurement, and a heating/cooling period.

25. A method according to claim 24, comprising determining the power input in dependence on a design target heat loss coefficient such that the building portion reaches the cut-off temperature and/or the desired maximal internal to external temperature difference at the end of the heating/cooling period.
